(19) United States
(12) Patent Application Publication
(10) Pub. No.: US 2005/0194296 A1
(43) Pub. Date: Sep. 8, 2005

(54) pH measurement system for buoyant water chlorinator

(76) Inventor: Fong -Jei Lin, Saratoga, CA (US)

Correspondence Address: Warren P. Kujawa, 1770 N. Green Valley Pkwy, Unit 3833, Henderson, NV, 89074, US

(21) Appl. No.: 10/792,303

(22) Filed: Mar. 3, 2004

(51) Int. Cl. B01D 35/14

(52) U.S. Cl. 210/85; 324/439

(57) ABSTRACT

A buoyant water conditioner has a pH measurement system with a pH sensor, a pH measurement circuit, a display for displaying measured pH values, and a processor. After immersing the sensor in water of known pH value, the processor performs a calibration routine in response to the operation of a calibration switch. If the calibration succeeds, the sensor is immersed in water of unknown pH value, and the processor performs a pH measurement routine when a start switch is operated. Both routines include a delay period during which no pH values are displayed. If the calibration is not successful, the calibration routine is repeated until it succeeds. The calibration and start switches are mounted on an upper surface of the water conditioner housing. The system is powered by a solar cell battery or a chemical battery.

### CROSS-REFERENCE TO RELATED PATENT

This invention is an improvement over the invention disclosed and claimed in commonly-owned U.S. Pat. No. 6,238,553 issued May 29, 2001 for “Buoyant Water Chlorinator With Temperature, pH measurement, and Chlorine Concentration Displays”.

### BACKGROUND OF THE INVENTION

This invention relates generally to water chlorination units of the type used in pools and spas. More particularly, this invention relates to a measurement circuit with simple calibration for use with a buoyant water chlorinator unit which measures water temperature, water pH, and chlorine concentration.

Water chlorination units are known which are used to supply chlorine to water in pools for water purification. Several such units are buoyant with an inner chamber providing a containment volume for the chlorination material, typically one or more solid pellets, with the containment volume having openings through the walls thereof so that the chlorination material can dissolve in the surrounding water.

The buoyant water chlorinator disclosed and claimed in my U.S. Pat. No. 6,238,553 comprises a buoyant housing with a lower apertured chamber for holding chlorine material, such as solid tablets. A removable cover retains the chlorine material in place. A plurality of measurement systems, each microprocessor-based, is carried by the housing. Each system has an easily-readable display, preferably mounted on the periphery of an upper housing surface, each display preferably comprising a liquid crystal display (LCD). One measurement system comprises a temperature sensor, such as a thermistor, for measuring the temperature of the ambient water. Electrical temperature signals produced by this sensor are coupled to a microprocessor programmed to convert these signals to signals capable of driving the associated display. A second measurement system comprises a pH level sensor for measuring the pH level of the ambient water. Electrical signals produced by this sensor are coupled to a microprocessor programmed to convert these signals to signals capable of driving the associated display. The remaining measurement system comprises an oxidation reduction potential sensor in the form of a chlorine concentration sensor for measuring the chlorine concentration of the ambient water. Electrical signals produced by this sensor are coupled to a microprocessor programmed to convert these signals to signals capable of driving the associated display.

Electrical power is supplied to each measurement system from a power source contained within the housing. One suitable power source is a solar cell battery mounted on the same surface as the displays. Another source is a battery installed in a battery compartment. Both types of power source may be included and either source may serve as the primary power source for all systems, with the remaining source reserved as a back-up source, or the two sources may both serve as primary sources for different systems.

The invention is used by placing it in the body of water in a pool or spa and observing the display values at intervals chosen by the user. When the displays indicate that the pH or chlorine concentration values need to be adjusted and that chlorine material must be added to the chlorine chamber, the cover is removed, and the fresh material is dropped into the receptacle chamber.

In order to provide accurate signals specifying the pH level of the ambient water, the pH measurement system must be initially calibrated, and the calibration should preferably be checked each time before taking a measurement. Known pH measurement systems do include calibration circuitry, but the technical expertise required to operate such circuitry is typically well beyond the capabilities of the normal consumer. What is needed is a pH measurement system for use with a consumer-oriented buoyant water chlorinator which requires no technical expertise to calibrate and operate in the measurement mode.

### SUMMARY OF THE INVENTION

The invention comprises a low cost pH measurement system for use with a buoyant water chlorinator which requires only simple calibration steps well within the grasp of any technologically-disadvantaged consumer, but which provides accurate calibration and pH readings in use.

From an apparatus standpoint, the invention comprises a pH measurement system for a buoyant water chlorinator, the measurement system having a pH sensor for generating signals representative of pH level of a liquid, such as pool or spa water, a pH measurement circuit for converting signals output by the pH sensor to voltage signals representative of pH level; a pH level display for displaying the value of the liquid pH, and a processor coupled to the pH measurement circuit and the pH level display for converting the voltage signals representative of pH level to pH level display driving signals. A manually operable calibration switch is coupled to the processor for initiating a calibration routine performed by the processor. A manually operable start switch is coupled to the processor for initiating a liquid sample measurement routine performed by the processor. The calibration and start switches are preferably mounted on the upper surface of the housing for the buoyant water chlorinator. Electrical power is provided to the sensor, the circuit, the processor and the display by a solar cell or a chemical battery.

The calibration routine includes a first delay period during which the voltage signals representative of pH level are not displayed on the pH level display. Similarly, the liquid sample measurement routine includes a second delay period during which the voltage signals representative of pH level are not displayed on the pH level display.

The pH measurement circuit includes a plurality of operational amplifiers, a first resistance for setting the value of an isopotential voltage coupled to the amplifiers, a second resistance for setting the value of a calibration voltage coupled to the amplifiers, and a third variable resistance for adjustably setting the value of a slope voltage coupled to the amplifiers. The first and second resistances are preferably fixed value resistors.

From a process standpoint, the invention comprises a method of measuring the pH value of water held by a confinement vessel, such as a pool or spa, the method comprising the steps of (a) providing a pH measurement system having a pH sensor for generating signals representative of pH level of water, a pH measurement circuit for converting signals output by the pH sensor to voltage signals representative of pH level; a pH level display for displaying the value of the water pH, a processor coupled to the pH measurement circuit and the pH level display for converting the voltage signals representative of pH level to pH level display driving signals, a manually operable calibration switch coupled to the processor for initiating a calibration routine performed by the processor, a manually operable start switch coupled to the processor for initiating a water sample measurement routine performed by the processor; and a source of electrical power for providing power to the sensor, the circuit, the processor and the display; (b) immersing the pH sensor in a water sample of known pH value; (c) applying electrical power to the sensor, the measurement circuit, the display, and the processor; (d) operating the calibration switch to initiate the calibration routine; (e) delaying the display of the voltage signals representative of pH level for a first delay period; (f) after the end of the first delay period, displaying the voltage signals representative of the pH level of the water sample; and (g) comparing the displayed pH level value with the known pH value.

If the displayed pH level value does not match the known pH value, the calibration routine is repeated by removing power from the system; reapplying power to the system; and repeating steps (b) through (g) above.

When the displayed pH level value matches the known pH value at the end of the calibration routine, a water sample measurement is performed by (h) immersing the pH sensor in water of unknown pH value; (i) applying electrical power to the sensor, the measurement circuit, the display, and the processor; (j) operating the start switch to initiate the liquid sample measurement routine; (k) delaying the display of the voltage signals representative of pH level for a second delay period; and (l) after the end of the second delay period, displaying the voltage signals representative of pH level of the water sample.

The step (b) of immersing is usually preceded by the step of selecting a water sample of pH value lying at the mid-point of the expected range of pH values of the water.

The steps (b) and (c); the steps (h) and (i); or all of them can be performed in reverse order by first applying electrical power to the system, and then immersing the sensor in the water.

The invention enables a consumer/user who is not even moderately technically oriented or skilled to easily conduct accurate pH measurements on pool or spa water. Moreover, any water sample measurement can be initiated by the user in full confidence of the accuracy of the measurement to be obtained by virtue of the automatic calibration routine which is initiated by the mere press of a switch button.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a schematic view of the preferred embodiment of the invention;

FIG. 2 is a top plan view of the invention of FIG. 1;

FIG. 3 is a block diagram of the temperature measurement system of the invention;

FIG. 4 is a block diagram of the pH measurement system of the invention;

FIG. 5 is a block diagram of the chlorine concentration measurement system of the invention;

FIG. 6 is a circuit schematic of the pH measurement circuit of the invention;

FIG. 7 is a schematic diagram illustrating the factory calibration process for the invention;

FIG. 8 is a schematic diagram illustrating the calibration check procedure; and

FIG. 9 is a schematic diagram illustrating the pH measurement procedure.

### DETAILED DESCRIPTION OF THE PREFERRED EMBODIMENTS

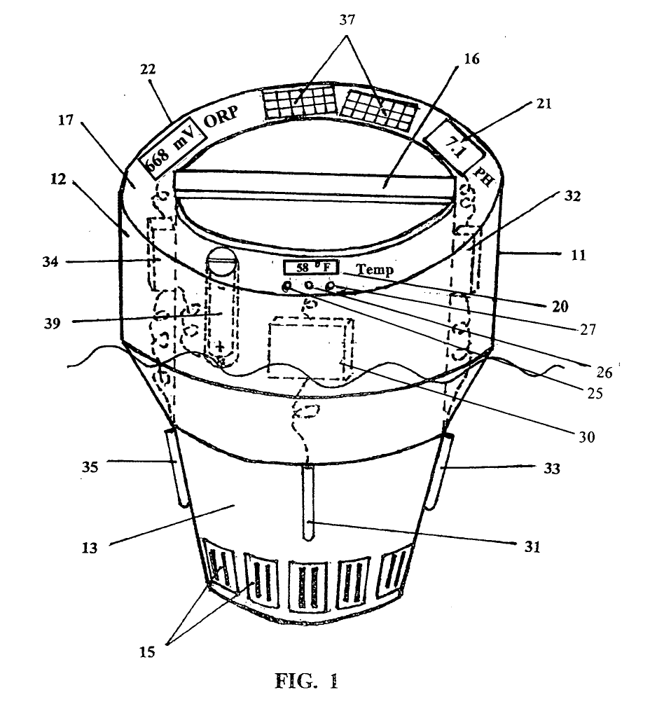

Turning now to the drawings, FIG. 1 is a schematic view illustrating the preferred embodiment of the invention. As seen in this FIG., the preferred embodiment includes a housing 11, typically made from plastic material. Housing 11 has an upper sealed hollow space 12 to ensure buoyancy in water, and a lower wall portion 13 providing a hollow interior for receiving one or more water-soluble chlorine tablets (not shown). A plurality of adjustable openings 15 are distributed about the circumference of lower wall portion 13 to allow water to enter the hollow interior volume and leach chlorine from the tablets. A cover 16 is removably mounted to the top of housing 11. To add more chlorine tablets, cover 16 is removed to expose the hollow lower interior.

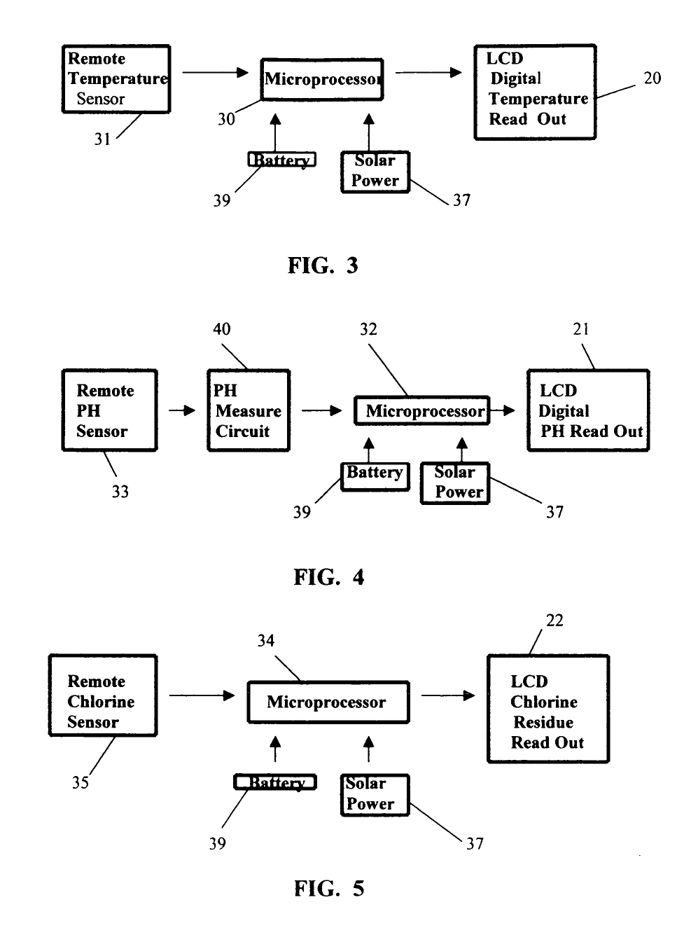

Arranged about the upper peripheral surface 17 of housing 11 are three liquid crystal (LCD) displays 20-22. Display 20 is a water temperature display and is electrically coupled to a microprocessor-based temperature processing unit 30 shown in FIG. 3, which receives water temperature measurement signals from a temperature sensor 31. Display 21 is a pH level display and is electrically coupled to a microprocessor-based pH level processing unit 32 shown in FIG. 4, which receives pH level signals from a pH electrode 33. Display 22 is an oxidation reduction (ORP) display and is electrically coupled to a microprocessor-based chlorine concentration processing unit 34, which receives signals from an oxidation reduction potential sensor 35.

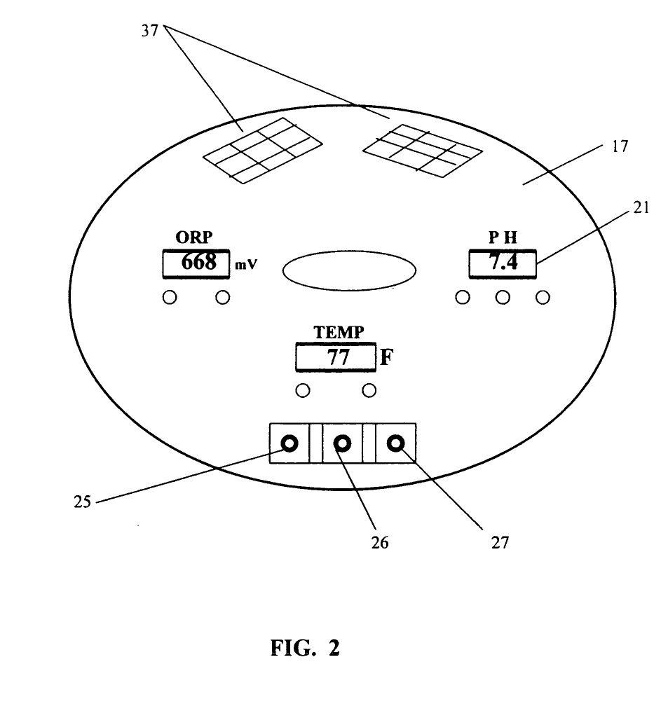

With reference to FIG. 2, mounted on upper peripheral surface 17 are three manually operable switches 25-27. In the preferred embodiment, switch 25 is a push button toggle switch, while switches 26 and 27 are push button momentary contact switches; however, other switch types can be used, if desired. Switch 25 is a main power switch: operation of this switch applies power to the three measuring circuits described below. Switch 26 is a calibration switch: operation of this switch enables automatic calibration of the pH measurement circuit. Switch 27 is a start switch: operation of this switch enables the pH measurement circuit to commence pH measurement of the water in which the chlorinator is suspended. Electrical power is supplied to the displays 20-22, sensors 31, 33, and 35, and processing units 30, 32, and 34 by one or more solar cells 37 mounted on the upper peripheral surface 17 of housing 11. An alternate source consisting of a battery (not shown) mounted in an appropriate portion of housing 11 is also provided.

FIG. 3 is a block diagram of the water temperature measurement system described above. As seen in this FIG., remote temperature sensor 31, which may comprise any one of a number of commercially available devices capable of generating signals representative of the temperature of the water with which the unit 31 comes in contact (such as a thermistor), has an output electrically coupled to the microprocessor unit 30. Microprocessor unit 30 may comprise any known microprocessor capable of receiving the signals from sensor 31 and converting these signals to signals capable of operating display 20. One such microprocessor is a type 16F877 available from Microchip corporation. The display output of microprocessor unit 30 is electrically coupled to the display input terminals of display 20, which displays temperature value in the form of integers plus an indication of the scale employed (i.e., Fahrenheit, Celsius, or some other scale).

FIG. 4 is a block diagram of the pH measurement system described above. As seen in this FIG., remote pH electrode 33 has a signal output electrically coupled to a pH measurement circuit 40 described below. The output of circuit 40 is coupled to a microprocessor unit 32. Electrode 33 may comprise any one of a number of commercially available sensors capable of generating electrical signals representative of the pH level of water with which the electrode 33 comes in contact (such as the sensor component incorporated into the series H-58800 pH meters available from ATI-Orion Research, Inc.). Microprocessor unit 32 may comprise the same type of unit as microprocessor unit 30, with different programming to convert the pH input signals to signals capable of operating display 21. The display output of microprocessor 32 is electrically coupled to the display input terminals of display 21, which displays pH values in the normal form of an integer, a decimal point and another integer.

FIG. 5 is a block diagram of the ORP chlorine concentration system described above. As seen in this FIG., chlorine sensor 35 has a signal output electrically coupled to microprocessor 34. Sensor 35 may comprise any one of a number of known sensors capable of generating signals representative of the ORP (usually in millivolts) of water with which sensor 35 comes in contact. The ORP is related to chlorine concentration in a known manner. Microprocessor unit 34 may comprise the same type of unit as microprocessor unit 30, with different programming to convert the ORP signals supplied by sensor 35 to signals capable of operating display 22. The display output of microprocessor unit 34 is coupled to the input terminals of display 22, which displays ORP in the form of three integers and the legend “mv”.

As illustrated in FIGS. 3-5, each unit is electrically powered by either solar cells 37, a battery 39, or a combination of the two. More specifically, if one or two of the systems shown in FIGS. 3-5 draws substantially more power than the others, either the solar cells 37 or the battery 39 may be dedicated to the unit(s) with a higher power consumption, with the remaining power source shared among all three systems. In the alternative, one of the two power sources (e.g., solar cells 37) may serve as the principal power source for all three units, and the other source used as a back-up source.

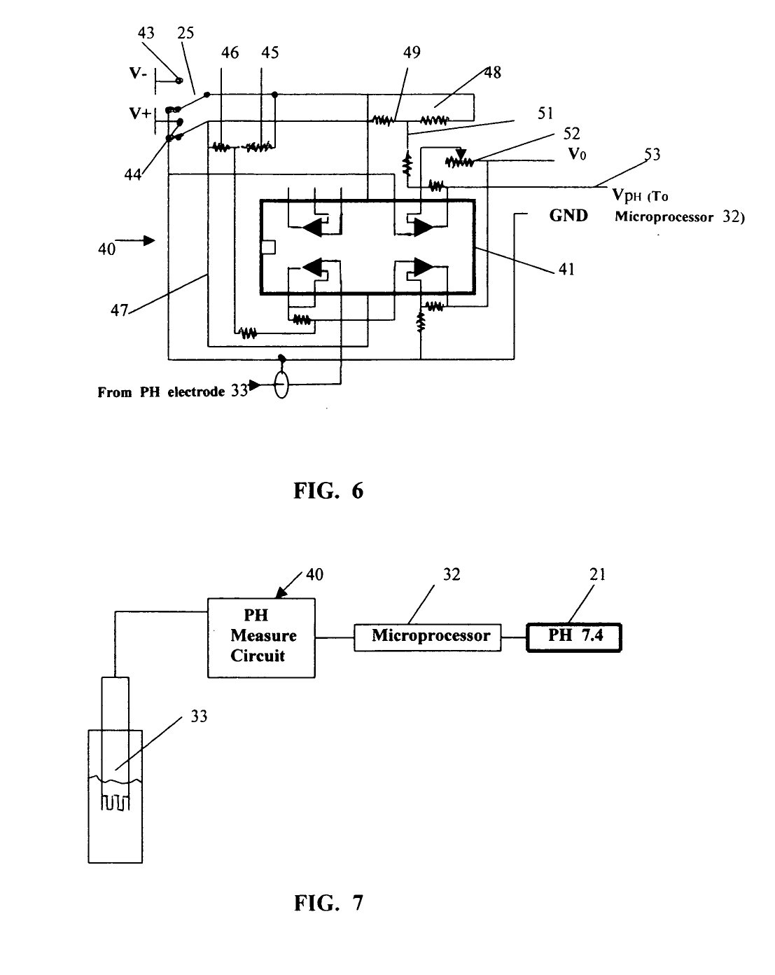

FIG. 6 is a circuit schematic of the pH measurement circuit 40 of the invention. As seen in this FIG., a voltage signal from pH sensor electrode 33 is coupled to one input of a conventional quad op amplifier 41. Amplifier 41 is preferably a commercially available type LF 347 JFET device. Supply voltage from sources 37, 39 is applied to input terminals 43, 44 of power switch 25. A pair of resistors 45, 46 provides an isopotential voltage of appropriate level to amplifier 41 via conductor 47. Another pair of resistors 48, 49 provides a calibration voltage of appropriate level to amplifier 41 via conductor 51. A single adjustment potentiometer 52 provides a slope adjustment capability for amplifier 41. The voltage on output terminal 53 is coupled to the voltage measurement input of microprocessor 32.

The circuit of FIG. 6 is a simplified modification of the pH measurement circuit disclosed in the technical publication entitled “A Low-Cost pH Meter for the Classroom” authored by David L. Harris et al found in the Journal of Chemical Education, Volume 69, Number 7, July, 1992, the disclosure of which is hereby incorporated by reference. The circuit shown in this technical publication employs three adjustment potentiometers: one for adjusting the isopotential voltage; one for the calibration voltage; and one for the slope adjustment. In contrast, the circuit of FIG. 6 incorporates only one adjustment potentiometer 52 for slope adjustment.

The circuit of FIG. 6 is initially calibrated at the factory in the following manner illustrated in FIG. 7. With display 21 connected to microprocessor 32, pH sensor electrode 33 is initially immersed in a buffer solution of known pH—7.0 in the process illustrated in FIG. 7—and allowed to equilibrate for a preselected period of time. Potentiometer 52 is adjusted as necessary until display 21 displays the correct known pH value of the buffer solution. Next, pH sensor electrode 33 is immersed in a second buffer solution of different known vaule—7.4 in FIG. 7—and the value displayed by display 21 is observed. Potentiometer 52 is adjusted as necessary until display 21 displays the correct known pH value of the second buffer solution. If adjustment was found necessary for the measurement of the second buffer solution, the process is repeated until the best fit between the two value readings is obtained. Since the range of pH values normally encountered in swimming pools and spas is normally quite small—in the range from about 7.2 to about 7.8—adjustment of the slope by means of potentiometer 52 will typically provide a linear range for the measurement circuit 40 for the values of interest to swimming pool and spa users.

Once factory calibration is complete, the unit is ready for use by the consumer. With reference to FIG. 8, the user initially immerses the pH sensor electrode 33 in a buffer solution of known pH value—preferably 7.5 (the mid-range value for swimming pools and spas)—and operates the calibrate switch 26. Operation of the calibrate switch 26 starts a calibration program routine in microprocessor 32 which provides an initial delay period (thirty seconds in the preferred embodiment) before measuring the value of the voltage output from pH measurement circuit 40. After the delay period, microprocessor 32 measures the output voltage, and causes display 21 to display the corresponding pH value. The user then observes this value on display 21. If the displayed pH value matches the known value of the buffer solution (7.5), the unit is ready for a water sample measurement. If the display is incorrect, the user is instructed to operate power switch 25 a first time to turn off the circuit 40, and to operate power switch 25 a second time to turn the power back on. This is followed by repeating the calibration procedure by operating calibration switch 26 and observing the displayed pH value with pH sensor electrode 33 still immersed in the 7.5 pH buffer solution. Any variance between the pH value displayed at the end of the calibration procedure will normally be due to circuit drift due to ambient conditions. In practice, any such variance will quickly disappear and the correct pH calibration value will be displayed.

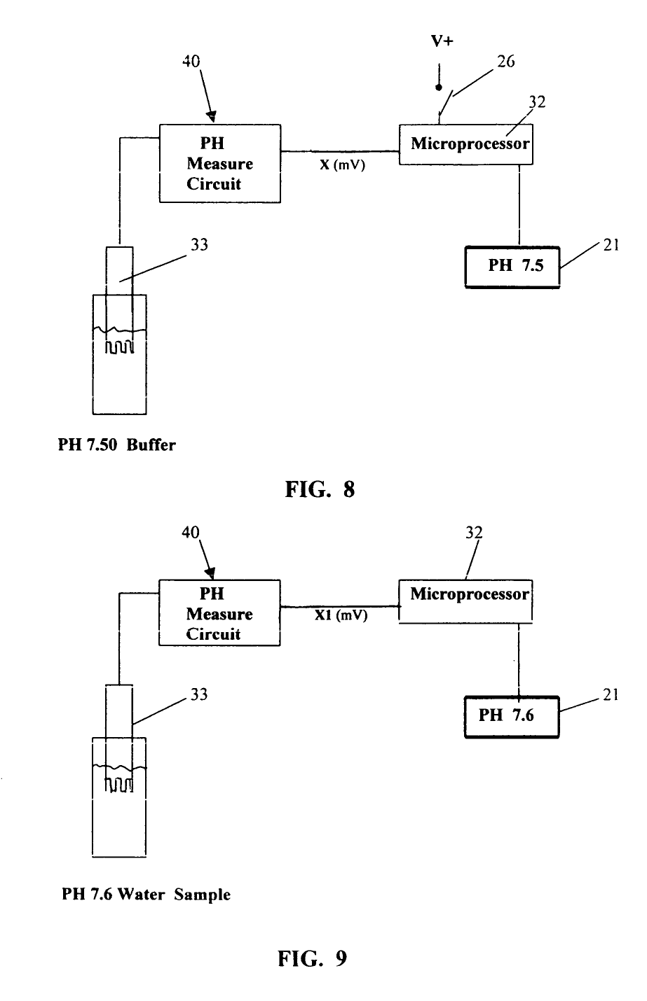

After the automatic calibration procedure is successfully completed, a water sample measurement is obtained by the user by the procedure illustrated in FIG. 9. The user immerses the pH sensor electrode 33 in a water sample (usually by immersing the electrode in the water immediately adjacent the chlorinator unit) and operates the start switch 27. Operation of the start switch 27 starts a sample measurement program routine in microprocessor 32 which provides an initial delay period (fifteen seconds in the preferred embodiment) before measuring the value of the voltage output from pH measurement circuit 40. After the delay period, microprocessor 32 measures the output voltage, and causes display 21 to display the corresponding pH value. The user then observes this value on display 21. If this value lies within the acceptable range (7.4 to 7.6 in the preferred embodiment) nothing further need be done. If this measured value lies outside the acceptable range, the user then can take corrective action, usually by adding more chlorine to the chlorinator unit.

As will now be apparent, the invention provides a simple procedure for the consumer/user to check the accuracy of the pH measurement circuit and to measure the pH value of the water in the user's pool or spa. The user need only operate a single switch 26 to check the calibration of the measurement circuit 40, and another switch 27 to take a water sample measurement. This eliminates the technical complexity of operating known pH measurement circuits, while ensuring the accuracy of water sample measurements. In addition, the calibration circuitry of the invention is relatively simple and thus can be manufactured at minimum cost.

Although the above provides a full and complete disclosure of the preferred embodiments of the invention, various modifications, alternate constructions and equivalents will occur to those skilled in the art. For example, although the invention has been described with reference to specific electronic components, other types of such components can be utilized, as desired. Moreover, different delay periods for the calibration and the water sample measurement routines can be incorporated into the invention. Therefore, the above should not be construed as limiting the invention, which is defined by the appended claims.

1. A pH measurement system for a buoyant water chlorinator, said measurement system comprising:
a pH sensor for generating signals representative of pH level of a liquid, a pH measurement circuit for converting signals output by said pH sensor to voltage signals representative of pH level; a pH level display for displaying the value of the liquid pH, and a processor coupled to said pH measurement circuit and said pH level display for converting said voltage signals representative of pH level to pH level display driving signals;
a manually operable calibration switch coupled to said processor for initiating a calibration routine performed by said processor;
a manually operable start switch coupled to said processor for initiating a liquid sample measurement routine performed by said processor; and
a source of electrical power for providing power to said sensor, said circuit, said processor and said display.

2. The invention of claim 1 wherein said calibration routine includes a first delay period during which said voltage signals representative of pH level are not displayed on said pH level display.

3. The invention of claim 1 wherein said liquid sample measurement routine includes a second delay period during which said voltage signals representative of pH level are not displayed on said pH level display.

4. The invention of claim 1 wherein said pH measurement circuit includes a plurality of operational amplifiers, a first resistance for setting the value of an isopotential voltage coupled to said amplifiers, a second resistance for setting the value of a calibration voltage coupled to said amplifiers, and a third variable resistance for adjustably setting the value of a slope voltage coupled to said amplifiers.

5. The invention of claim 4 wherein said first resistance is a fixed value resistance.

6. The invention of claim 4 wherein said second resistance is a fixed value resistance.

7. The invention of claim 1 wherein said source of electrical power comprises a chemical battery.

8. The invention of claim 1 wherein said source of electrical power comprises a solar cell.

9. The invention of claim 1 wherein said buoyant water chlorinator includes a buoyant housing having an upper surface; and wherein said calibration switch is mounted on said upper surface.

10. The invention of claim 1 wherein said buoyant water chlorinator includes a buoyant housing having an upper surface; and wherein said start switch is mounted on said upper surface.

11. A method of calibrating a pH measurement system having a pH sensor for generating signals representative of pH level of a liquid, a pH measurement circuit for converting signals output by said pH sensor to voltage signals representative of pH level; a pH level display for displaying the value of the liquid pH, a processor coupled to said pH measurement circuit and said pH level display for converting said voltage signals representative of pH level to pH level display driving signals, a manually operable calibration switch coupled to said processor for initiating a calibration routine performed by said processor, and a source of electrical power for providing power to said sensor, said circuit, said processor and said display; said method comprising the steps of:
(a) immersing the pH sensor in a liquid of known pH value;
(b) applying electrical power to the sensor, the measurement circuit, the display, and the processor;
(c) operating the calibration switch to initiate the calibration routine;
(d) delaying the display of the voltage signals representative of pH level for a first delay period;
(e) after the end of the first delay period, displaying the voltage signals representative of pH level;
(f) comparing the displayed pH level value with the known pH value; and
(g) proceeding to a liquid sample measurement if the displayed pH level value matches the known pH value.

12. The method of claim 11 wherein said step (a) of immersing is preceded by the step of selecting a pH value lying at the mid-point of the expected range of pH values of the liquid.

13. The method of claim 11 wherein steps (a) and (b) are performed in reverse order.

14. The method of claim 11 further including performing the following additional steps when the displayed pH level value does not match the known pH value:
(h) removing power from the system;
(i) reapplying power to the system; and
(j) repeating steps (a) through (f).

15. The method of claim 11 wherein said system further includes a manually operable start switch coupled to said processor for initiating a liquid sample measurement routine performed by said processor; and wherein said step (g) of proceeding is performed by the following steps:
(i) immersing the pH sensor in a liquid of unknown pH value;
(ii) applying electrical power to the sensor, the measurement circuit, the display, and the processor;
(iii) operating the start switch to initiate the liquid sample measurement routine;
(iv) delaying the display of the voltage signals representative of pH level for a second delay period; and
(v) after the end of the second delay period, displaying the voltage signals representative of pH level.

16. A method of measuring the pH value of water held by a confinement vessel, said method comprising the steps of:
(a) providing a pH measurement system having a pH sensor for generating signals representative of pH level of water, a pH measurement circuit for converting signals output by said pH sensor to voltage signals representative of pH level; a pH level display for displaying the value of the water pH, a processor coupled to said pH measurement circuit and said pH level display for converting said voltage signals representative of pH level to pH level display driving signals, a manually operable calibration switch coupled to said processor for initiating a calibration routine performed by said processor, a manually operable start switch coupled to said processor for initiating a water sample measurement routine performed by said processor; and a source of electrical power for providing power to said sensor, said circuit, said processor and said display;
(b) immersing the pH sensor in a water sample of known pH value;
(c) applying electrical power to the sensor, the measurement circuit, the display, and the processor;
(d) operating the calibration switch to initiate the calibration routine;
(e) delaying the display of the voltage signals representative of pH level for a first delay period;
(f) after the end of the first delay period, displaying the voltage signals representative of the pH level of the water sample;
(g) comparing the displayed pH level value with the known pH value; and
(l) if the displayed pH level value does not match the known pH value:
(h) removing power from the system;
(j) reapplying power to the system; and
(j) repeating steps (b) through (g);
(ll) when the displayed pH level value matches the known pH value, proceeding to a water sample measurement by:
(k) immersing the pH sensor in water of unknown pH value;
(l) applying electrical power to the sensor, the measurement circuit, the display, and the processor;
(m) operating the start switch to initiate the liquid sample measurement routine;
(n) delaying the display of the voltage signals representative of pH level for a second delay period; and
(o) after the end of the second delay period, displaying the voltage signals representative of pH level of the water sample.

17. The method of claim 16 wherein said step (b) of immersing is preceded by the step of selecting a water sample of pH value lying at the mid-point of the expected range of pH values of the water.

18. The method of claim 16 wherein said steps (b) and (c) are performed in reverse order.

19. The method of claim 16 wherein said steps (k) and (l) are performed in reverse order.
